(19) United States
(12) Patent Application Publication
(10) Pub. No.: US 2006/0279102 A1
(43) Pub. Date: Dec. 14, 2006

(54) Cover Systems For Vehicles

(76) Inventors: Ronald D. Carroll, Littleton, CO (US); Jeffry A. Hubbard, Northglenn, CO (US); Michael A. Breffle, Deer Trail, CO (US)

Correspondence Address: TRENNER LAW FIRM, LLC, 12081 WEST ALAMEDA PARKWAY #163, LAKEWOOD, CO, 80228, US

(21) Appl. No.: 11/424,180

(22) Filed: Jun. 14, 2006

Related U.S. Application Data
(60) Provisional application No. 60/690,410, filed on Jun. 14, 2005.

(51) Int. Cl. B60P 7/02

(52) U.S. Cl. 296/100.01

(57) ABSTRACT

Cover systems for vehicles are disclosed. An exemplary vehicle cover comprises a first housing base and a second housing base for mounting on a vehicle, each housing base having at least one channel formed therein. A pulley system is mounted in the first and second housing bases, the pulley system operable to move a cable through the at least one channel formed in each housing base. At least one support bow is mounted on one end to the cable in the at least one channel of the first housing base and mounted on an opposite end to the cable in the at least one channel of the second housing base, the at least one support bow moving between a retracted position and a closed position over the vehicle in response to operation of the pulley system.

### PRIORITY CLAIM

This application claims priority to co-owned U.S. Provisional Patent Application No. 60/690,410 for “Configurable Cover Systems And Methods Of Use” of Ronald D. Carroll, et al., filed Jun. 14, 2005, hereby incorporated by reference in its entirety as though fully set forth herein.

### BACKGROUND

It is often desirable, or sometimes even mandated, that trucks, trailers, and other vehicles that have an open area, be covered to help keep loads in the vehicle during transportation and/or help protect the load from weather (e.g., rain or snow). Accordingly, there is a wide variety of covers available for these vehicles, including, both hard and soft covers.

These covers are typically manufactured separately for specific types of vehicles, and even for specific configurations of the same type of vehicle. For example, some covers are manufactured specifically for pickup trucks, while separate covers are manufactured specifically for trailers. In addition, the same type of cover may be manufactured for different sizes of pickup trucks (e.g., long-bed and short-bed).

It has been difficult, if not impossible, to fit other types of vehicles with any sort of cover. By way of example, sport utility vehicles (SUVs) often have bed configuration which are specific to each SUV. Covers for these SUVs are typically custom made for the particular SUV. Custom covers such as these can be expensive. As another example, utility trucks often have asymmetrical bed configurations, and hence are not easily covered. For example, a utility truck may be configured with a storage box on one side of the bed and a platform for a crane or other tool on the opposite side of the bed. A loose tarp may be tied down at the corners of the utility truck to cover a load. However, this can be time consuming, and if not properly tied down, it may not offer good protection for the load.

### BRIEF DESCRIPTION OF THE DRAWINGS

FIGS. 1a-b are perspective views of an exemplary cover system as it may be implemented on a utility truck having uneven or asymmetrical sides, wherein the cover system is in (a) a fully closed position, and (b) a fully retracted position and with the curtain down on the truck bed.

FIGS. 2a-b are perspective views of the exemplary cover system shown in FIGS. 1a-b, wherein (a) shows the cover system with the canopy removed, and (b) is an exploded view of the cover system.

FIG. 3a-c are perspective views of an exemplary adjustable support bow, wherein (a) is an exploded view of the support bow, (b) is an assembled view of the support bow in a first configuration, and (c) is an assembled view of the support bow in a second configuration.

FIG. 4 is a cross-sectional view of an exemplary front bow mount as it may be provided in a track of a rail system.

FIG. 4a is a perspective view of the exemplary front bow mount shown in FIG. 4.

FIGS. 5a-b are cross-sectional view of a track of a rail system showing the support bows mounted to (a) an exemplary operating trolley, and (b) directly to a bearing assembly.

FIGS. 5c-d are perspective views of exemplary operating trolleys, such as the trolley shown in FIG. 5a, wherein (a) is a driver-side operating trolley, and (b) is a passenger-side operating trolley, both shown with attached cable tensioning spring.

FIG. 6 is an exploded view of part of an exemplary pulley system shown an exemplary pulley wheel and pulley mount for mounting the pulley wheel to a rail system.

FIG. 7 is a perspective view of an exemplary crank assembly that may be implemented to drive the pulley system.

FIG. 8 is a perspective view of an exemplary lock assembly for the rear curtain that may be implemented with exemplary cover systems.

FIG. 8(a) is an exploded view of the exemplary lock assembly shown in FIG. 8.

FIGS. 9a-c are partial perspective views showing support bows mounted in a housing base of an exemplary cover system to illustrate exemplary operation of the cover system.

FIGS. 10a-c are perspective view of another exemplary cover system which may be implemented on a pickup truck, wherein (a) shows the cover system in a fully retracted position, (b) shows the cover system in an intermediate stage, and (c) shows the cover system in a fully closed position over the bed of the pickup truck.

FIGS. 11a-b are perspective views of another exemplary cover system which may be side-mounted on a flatbed trailer, wherein (a) shows the flatbed trailer, and (b) shows the cover system in a fully closed position over the flatbed trailer.

FIGS. 12a-b are perspective view of another exemplary cover system which may be top-mounted on a flatbed trailer, wherein (a) shows the cover system in a partially retracted position, and (b) shows the cover system in a open position.

FIGS. 13a-b are perspective view of another exemplary cover system which may be mounted on a car hauling trailer, wherein (a) shows the car hauling trailer, and (b) shows the cover system in a closed position over the car hauling trailer.

FIG. 14 is a perspective view of an exemplary bulkhead that may be implemented with exemplary cover systems with flatbed trucks and trailers.

FIG. 15 is a perspective view of exemplary adapter rails that may be implemented with exemplary cover systems for pickup trucks.

FIGS. 16a-b are top views of and exemplary lock system that may be implemented for the trolleys showing (a) the trolley operated to automatically open the lock, and (b) the trolley in the locked position.

### DETAILED DESCRIPTION

Exemplary cover systems and methods of use are disclosed, e.g., for vehicles such as utility trucks, pickup trucks, SUVs, and other trucks and trailers. The cover system may be readily mounted to different parts of a vehicle (e.g., to the storage boxes of utility trucks and between rack systems on pickup trucks). At least some universal components may be manufactured and readily adjusted during assembly for use with a wide variety of different types, sizes, and configurations of vehicles.

Exemplary Systems

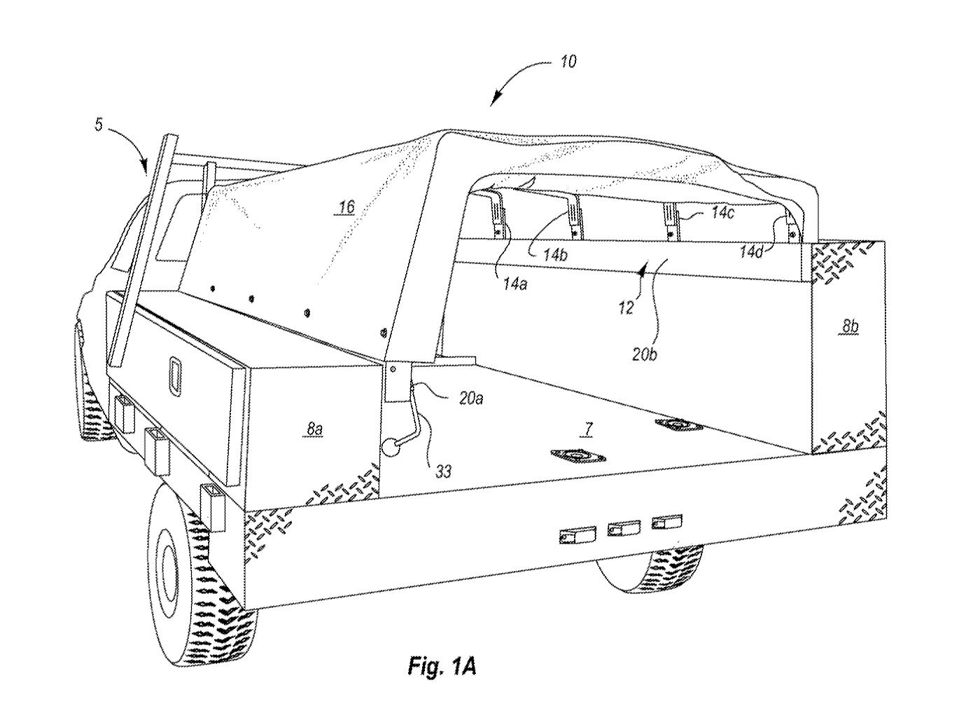

FIGS. 1a-b are perspective view of an exemplary cover system 10 as it may be implemented on a utility truck 5, wherein the cover system 10 is in (a) a fully closed position, and (b) a fully open or retracted position on the truck bed 7. Although cover system 10 is shown and described in FIG. 1 as it may be implemented with a utility truck 5, it is noted that cover system 10 may be used with any of a wide variety of different sizes, types, and/or configurations of vehicles. Some examples of different types of vehicles with which the cover systems may be used include, but are not limited to, pickup trucks, utility trucks, flatbed trucks and trailers, Jeeps®, SUVs, tractor-trailers, and utility trailers, to cover all or a portion of the vehicle (e.g., the truck bed). Therefore, the utility truck 5 shown in FIG. 1 will also be referred to more generally herein as a vehicle 5.

Exemplary cover system 10 may include a rail system 12 mounted to the vehicle 5, e.g., to the storage boxes 8a and 8b on the truck bed 7. One or more support bows 14a-d attach to and provide support for a canopy 16 that may be used to cover a portion of the vehicle 5 (e.g., the truck bed 7). Any number of support bows 14a-d may be implemented. The number of support bows 14a-d may depend at least in part on design considerations, such as, but not limited to, a desired span between the support bows 14a-d.

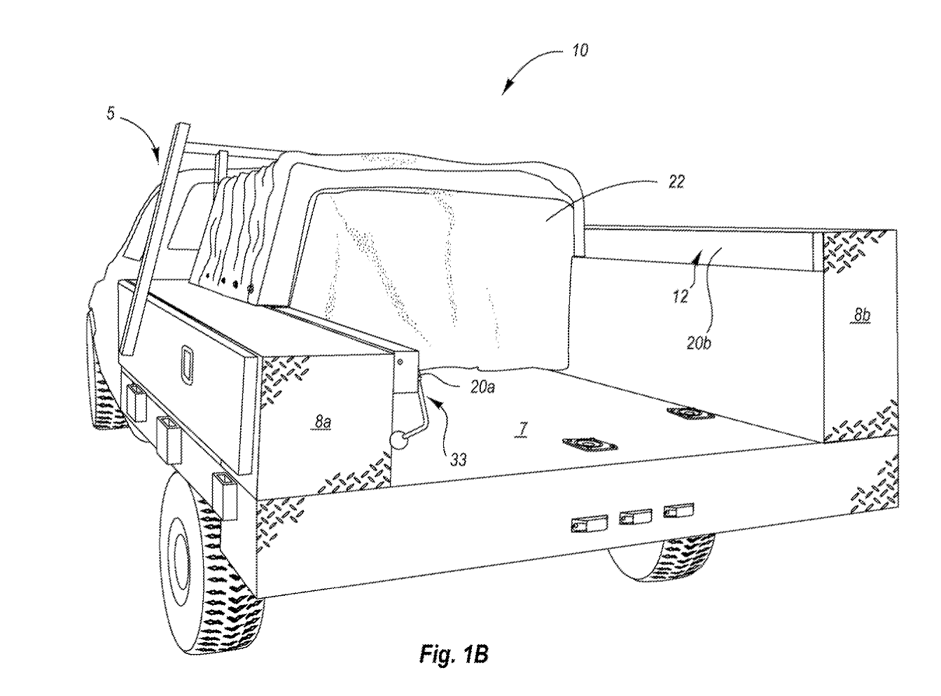

The support bows 14a-d may be movably mounted to the rail system 12, e.g., via a pulley system 18 shown in FIG. 2b. The pulley system 18 may be operated to move the support bows 14a-d to at least partially open and close the canopy 16 over a portion of the vehicle 5, e.g., as illustrated by the open and closed positions shown in FIGS. 1a and 1b, respectively.

In exemplary embodiments, the rail system 12 includes first and second housing bases 20a-b. The housing bases 20a-b may be readily mounted to different parts of the vehicle 5 regardless of configuration of the vehicle, such as on the lower storage box 8a and higher storage box 8b in FIGS. 1a and 1b.

Still other embodiments of cover system 10 are also contemplated. For example, the canopy 16 may be provided with an optional curtain 22. Although not shown in FIG. 1b, the curtain 22 may include a transparent window, e.g., manufactured of clear vinyl, hard plastic, or glass. The sides and/or top of the canopy 16 may also include one or more transparent windows.

The canopy 16 may be manufactured of a water-proof cloth, canvas, plastic coated sheeting, or other suitable material, to list only a few examples. It is well understood in the industry how to attach canopies to vehicles in a water-tight manner. These methods for attaching canopies include, but are not limited to, rivets, ties, or sleeves which may be used to attach the canopy 16 to one or more of the support bows 14a-d. Zippers, Velcro®, protective flaps, interlocking plastic beading, and other attachments may also be implemented to provide a water-tight cover system. For example, a bead lock 17a is shown in FIG. 2b as it may be mounted to the rail system 12 (e.g., on shaft cover 38). Bead lock 17a may be configured to receive a mating “hot-rolled round” 17b sewn into a front panel (not shown) of canopy 16 to provide a removable and water-tight attachment between the front panel of canopy 16 and the rail system 12.

With reference again to FIGS. 1a and 1b, the canopy 16 may be removable so that the canopy 16 can be replaced (e.g., if it becomes torn or faded) without having to replace the entire cover system 10. In addition, the canopy 16 may be disconnected from one or more of the support bows 14a-d to enable the canopy 16 and support bows 14a-d to be moved to the front, the center, or the rear of the vehicle 5. For example, the canopy 16 may be removed from front support bow 14a so that the other support bows 14b-c can be moved to the rear of the vehicle 5 for adding or removing a load (not shown) in the front of the truck bed 18.

FIGS. 2a-b are perspective views of the exemplary cover system 10 shown in FIGS. 1a and 1b, wherein (a) shows the cover system 10 with the canopy 16 removed, and (b) is an exploded view of the cover system 10. The rail system 12 and support bows 14a-d can be seen in FIG. 2a as these may be mounted on opposite ends to the housing bases 20a-b. Additional exemplary components of the cover system 10 can be better seen in FIG. 2b. Only one of the support bows (generally referred to as support bow 14) is shown in FIG. 2b for purposes of simplicity.

Covers 24a-b and end caps 26a-b are shown removed from the housing bases 20a-b to show the exemplary pulley system 18 in more detail. It is noted that covers 24a-b and end caps 26a-b are optional and may be provided to help protect components of the pulley system 18 against damage, e.g., during loading or unloading of cargo in the truck bed 18.

In an exemplary embodiment, the pulley system 18 includes a front pulley wheel 28a-b mounted to the front of each housing base 20a-b, and a rear pulley wheel 30a-b mounted to the rear of each housing base 20a-b. Pulley wheels 28a-b and 30a-b are provided to move cables 32a-b in housing base 20a-b, respectively. Cables 32a-b may each be provided with a tensioning spring 34a-b to enhance movement of the cables 32a-b in response to operation of the pulley system 18.

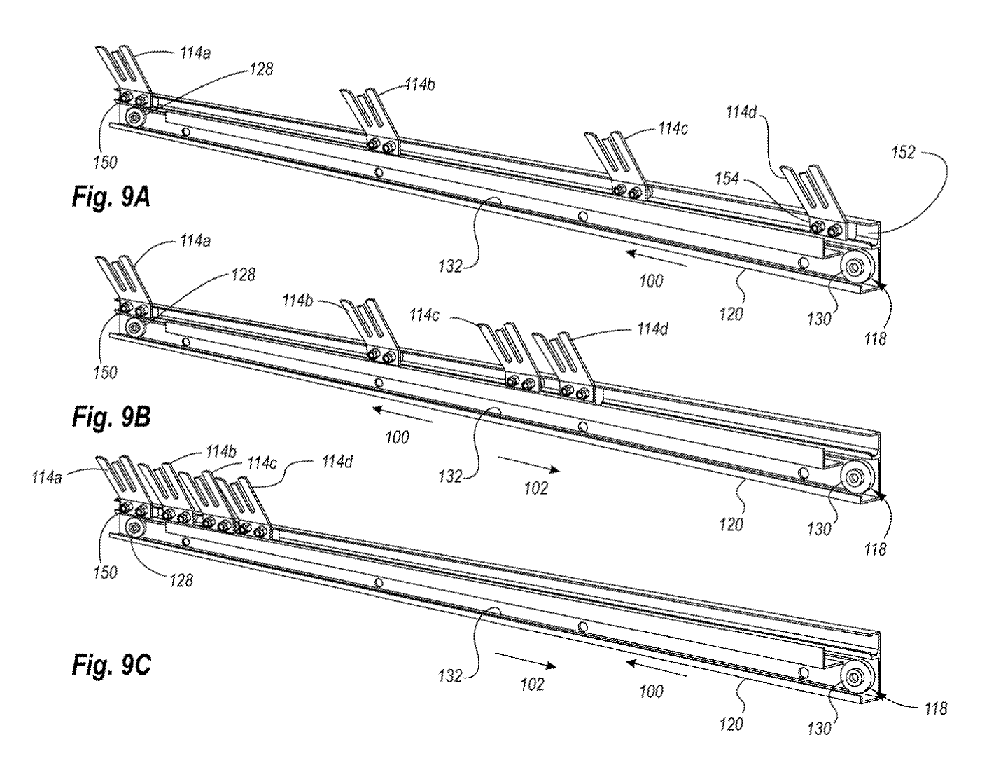

Pulley system 20 may also include a crank assembly 33. Crank assembly 33 may be permanently or removably connected to one of the pulley wheels (e.g., the rear pulley wheel 30a in housing base 20a as shown in FIG. 2a) and rotated to effect movement of the pulley system 18. For example, the crank assembly 33 may be manually operated to rotate the rear pulley wheel 30a in housing base 20a. Rotation of the rear pulley wheel 30a is translated by cables 32a-b and by shaft 36 connected between pulley wheels 28a-b to each of the other pulley wheels in the pulley system 18 to effect movement of the support bows 14a-d, as explained in more detail below with reference to FIGS. 9a-c. It is noted that the shaft 36 helps ensure that the cables 32a-b both move at substantially the same rate and in the same direction so as to effect smooth, consistent or substantially uniform movement of the support bows mounted on each side of the cover system 10. This uniform movement helps reduce or altogether prevent jamming or “hang-ups” during operation.

In an exemplary embodiment, only one of the pulley wheels is driven to effect movement of the other pulley wheels at about the same speed and in the same direction. This operation also helps ensure substantially uniform movement of the cables 32a-b, and hence substantially uniform movement of both sides of the rear support bow 14d. Accordingly, the rear support bow 14d can be operated to open and close the canopy over the truck bed 18 without the jamming that may occur if the same support bow 14d traveled faster on one side than on the opposite side.

It is noted that operation of the pulley system 18 is not limited to the crank assembly 33 shown in FIGS. 2a and 2b. Nor is the pulley system 18 limited to manual operation. In other embodiments, operation of the pulley system 18 may be effected by an automatic drive (e.g., an electric drill or other electric motor) permanently or removably connected to one or more of the pulley wheels 28a-b or 30a-b.

It is also noted that the shaft 36 may be connected between the front pulley wheels 28a-b by universal joints (not shown). A universal joint enables a connection between the front pulley wheels 28a-b even if the housing bases 20a-b (and hence pulley wheels 28a-b) are mounted in different planes relative to one another (e.g., at different heights on opposite sides of the truck bed 7, as illustrated in FIGS. 1a and 1b). Optionally, a shield of shaft cover 38 may be provided over the shaft 36. Shaft cover 28 may be provided to help protect the shaft 36 from becoming jammed during operation (e.g., by cargo in the truck bed 7 wedging against the shaft 36), and/or against damage (e.g., during loading or unloading of cargo in the truck bed 7).

Other mechanisms for effecting substantially uniform movement of one or more of the support bows 14a-d are also contemplated. Such other mechanisms for effecting substantially uniform movement will be readily appreciated by those having ordinary skill in the art after becoming familiar with the teaching herein.

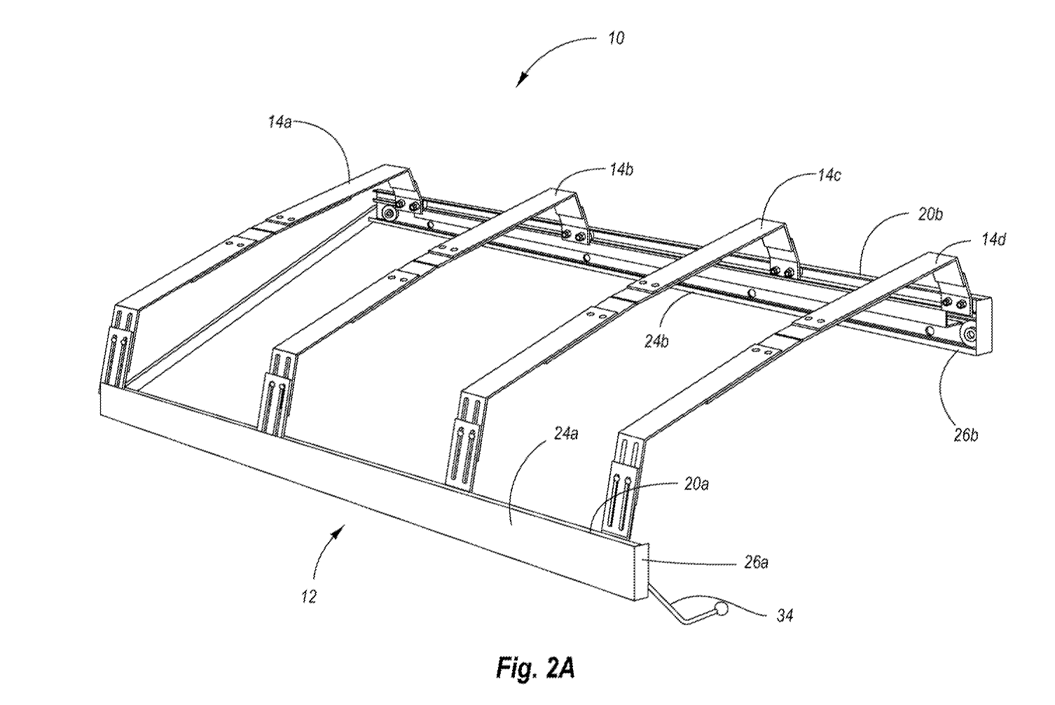

FIGS. 3a-c are perspective view of an exemplary support bow 14, wherein (a) is an exploded view of the support bow 14, (b) is an assembled view of the support bow 14 in a first configuration, and (c) is an assembled view of the support bow 14 in a second configuration. In an exemplary embodiment, the support bows 14 may be manufactured of a flexible material, such as a flexible plastic. However, the support bows 14 may be manufactured of any suitable material.

Optionally, the support bows 14 (e.g., support bows 14a-d shown in FIGS. 1a-b and FIG. 2a) may be implemented as universal support bows which may be readily adjusted to fit across different dimensions and configurations of vehicles. Accordingly, the cover system 10 may be implemented for any of a wide variety of different types and configurations of vehicles.

In an exemplary embodiment, a universal support bow (referred to generally as 14 in FIGS. 3a-c) may include lower bow portions 40a-b connected to upper bow portions 42a-b. The upper bow portions 42a-b may be interconnected by a bow coupler 44. Bow coupler 44 may include first and second coupler portions 46a-b, as shown in FIGS. 3a-c. Alternatively, bow couple 44 may be manufactured as a single component. It is noted that the lower bow portions 40a-b, upper bow portions 42a-b, and first and second coupler portions 46a-b may be manufactured as substantially uniform components regardless of whether the component will be installed on the left or right side of the support bow 14.

In an exemplary embodiment, the lower bow portions 40a-b and upper bow portions 42a-b have elongated slots 41a-b and 43a-b formed therein, respectively. These elongated slots 41a-b and 43a-b enable the lower bow portions 40a-b to slide relative to the upper bow portions 42a-b during assembly. After the lower bow portions 40a-b and upper bow portions 42a-b are in the desired position, e.g., to provide the desired height (H) for support bow 14, fasteners 45 may be used to secure the lower portions 40a-b to the upper bow portions 42a-b to maintain the desired height (H) of support bow 14.

Also in an exemplary embodiment, the bow coupler 44 has elongated slots 47 formed therein. These elongated slots 47 enable the upper bow portions 42a-b to slide relative to the bow coupler 44 during assembly. After the upper bow portions 42a-b are in the desired position relative to the bow coupler 44, e.g., to provide the desired width (W) for support box 14, fasteners 49 may be used to secure the upper bow portions 42a-b to the bow coupler 44 to maintain the desired width (W) of support bow 14.

Accordingly, the support bow may be manufactured with substantially uniform components and configured during assembly to fit any of a wide variety of different sizes and configurations of vehicles. For example, a support bow 14 is shown assembled in a first configuration in FIG. 3b having a first width (W′) and first height (H′), and the same support bow 14 is shown assembled in a second configuration in FIG. 3c having a second width (W″) and second height (H″).

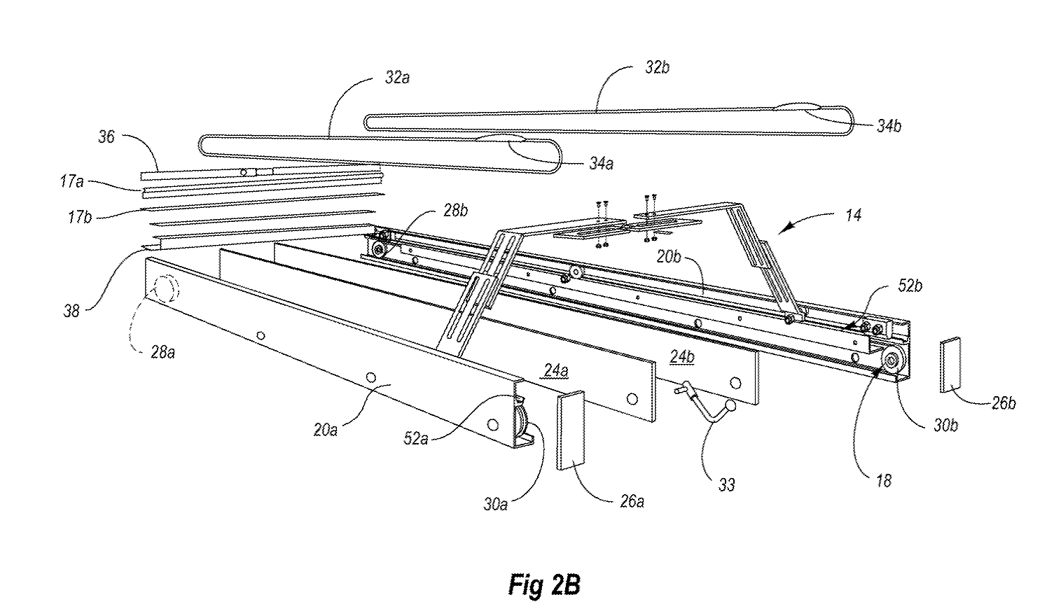

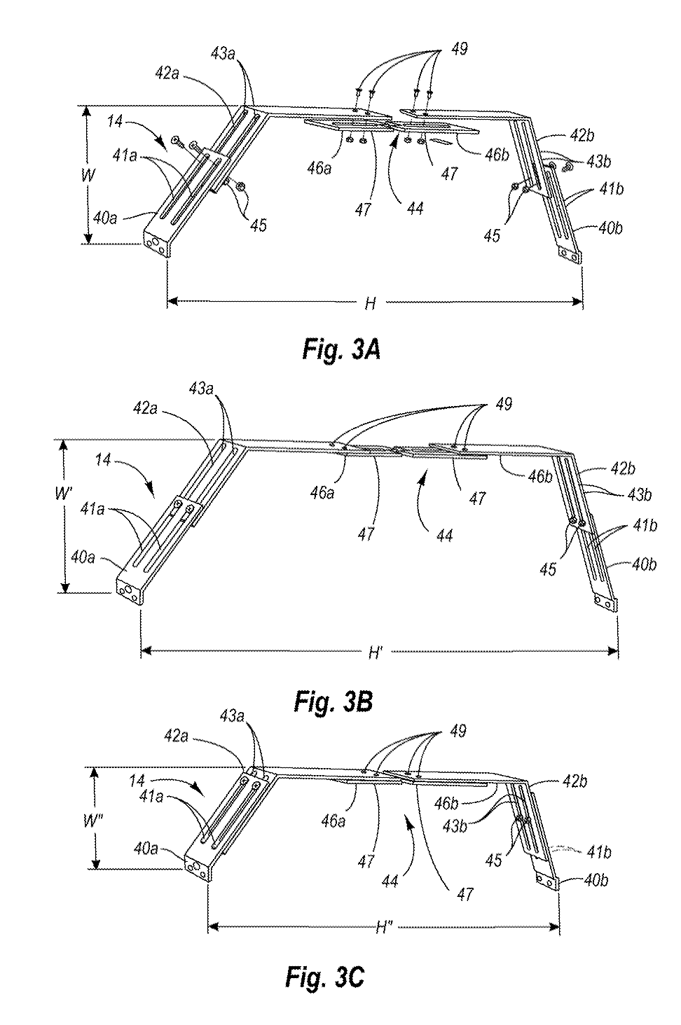

FIG. 4 is a cross-sectional view of an exemplary front bow mount 50 as it may be provided in a track 52 of the rail system 12. FIG. 4a is a perspective view of the exemplary front bow mount 50 shown in FIG. 4. In an exemplary embodiment, the shape of the front bow mount 50 may compliment the shape of the track 52a or 52b (generally referred to as track 52 in FIG. 4) so that the front box mount 50 can be fitted within the track 52 formed in the housing bases 30a-b. It is noted, however, that the front bow mount 50 is not limited to any particular size or shape.

Exemplary front bow mount 50 is shown is FIG. 4a having two threaded holes 53 formed therein to receive fasteners 51 for attaching each side of the front support bow 14a to the front bow mounts 50. Although a single fastener 51 may be used to secure the front support bow 14a to the front bow mounts 50, two or more fasteners 51 helps ensure that the front support bow 14a does not pivot about the front bow mount 50, which may otherwise cause the canopy 16 to at least partially collapse during use.

Exemplary front bow mount 50 may also be secured within the track 52 to the housing base so that it does not move during operation. Optionally, the front bow mount 50 may be secured by the same fastener 51 which is used to attach the front support bow 14a to the front bow mount 50.

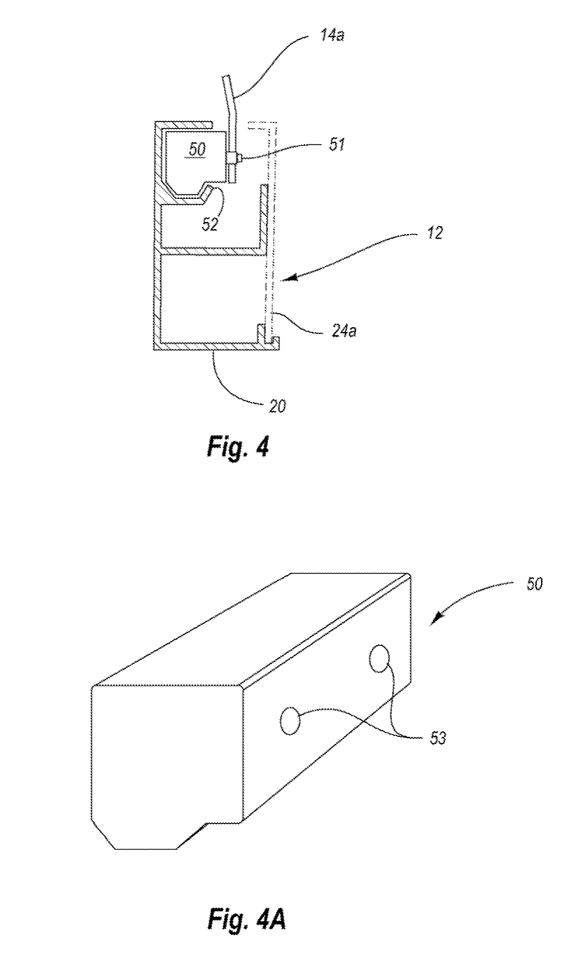

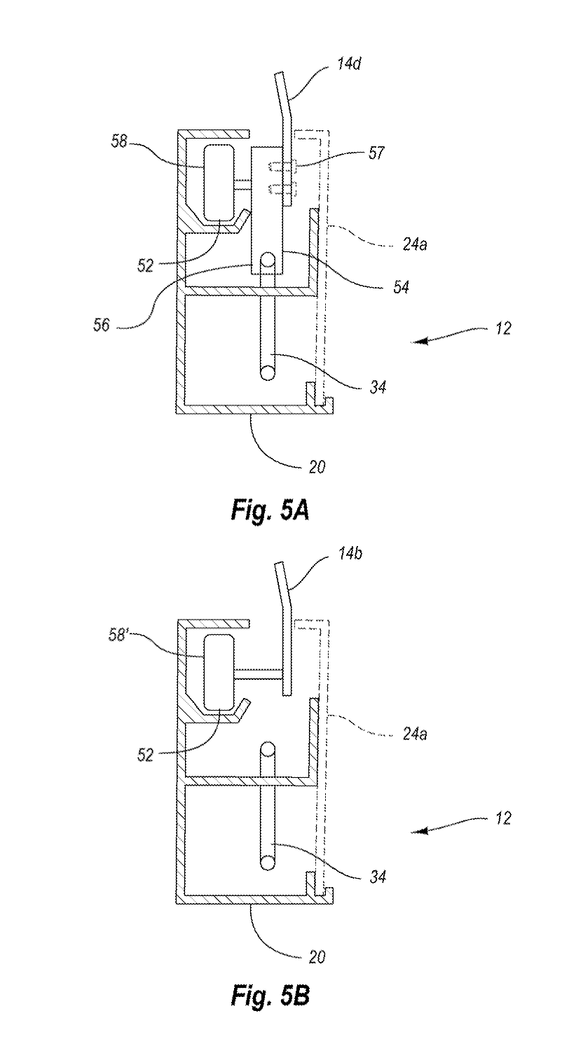

FIGS. 5a-b are cross-sectional view of a track of a rail system showing the support bows mounted to (a) an exemplary operating trolley, and (b) directly to a bearing assembly. FIG. 5a shows the exemplary operating trolley 54 as it may be provided to ride in a track 52 of the rail system 12. The operating trolley 54 may include a mounting portion 56 and at least one roller or bearing assembly 58 (e.g., sealed-bearing rollers) to facilitate movement of the trolley 54 through the track 52 formed in each of the housing bases 20a, 20b (generally referred to as housing base 20 in FIG. 5a) to move the rear support bow 14d.

FIG. 5b shows the support bows (e.g., support bows 14b-c) that are mounted between the front support bow 14a and rear support bow 14d with the bearing assembly 58′ attached directly to the support bows to ride in track 52 of the rail system 12. The bearing assembly 58′ facilitates movement of the support bows 14b-c through the track 52 formed in each of the housing bases 20a, 20b (generally referred to as housing base 20 in FIG. 5b) to move the support bows 14b-c.

In an exemplary embodiment, two rollers are provided for each side of each support bow 14. For example, two rollers are mounted one in each hole 59 on the operating trolley 54 (see, e.g., FIGS. 5c-d) for support bow 14d, and two rollers may also be mounted directly to each side of each support bows 14b-c. Two or more wheels help maintain the support bow 14 in a substantially upright position. In any event, the roller or bearing assembly 58 and 48′ enables the trolley 54 to readily slide through the track 52 formed in each of the housing bases 20.

FIGS. 5c-d are perspective views of exemplary operating trolleys, such as the trolley shown in FIG. 5a, wherein (a) is a driver-side operating trolley 54a, and (b) is a passenger-side operating trolley 54b, both shown with attached cable tensioning spring 34. Each of the trolleys (generally referred to as trolley 54 unless referring to a specific trolley) may include a mounting portion 56. Support bows 14 may be attached to the mounting portion 56 of the trolleys 54, e.g., using fastener(s) 57 in hole 59a formed in the mounting portion 56. Each of the trolleys may also include a roller or bearing assembly 58 (e.g., as shown in FIG. 5) mounted in holes 59 to enable movement of the trolleys 54 through track 52 in response to operation of the pulley system 18.

Exemplary operating trolleys 54a and 54b are shown in FIGS. 5c-d as these may be implemented for the rear-most support bow 14d. The operating trolleys 54a and 54b may move in direct response to movement of the cable 32. Accordingly, the cable 32 may be secured to the operating trolleys 54a and 54b so that movement of the cable 32 also causes the operating trolleys 54a and 54b to move.

In an exemplary embodiment, the cable 32 may be fed through the hole 62 formed in the mounting portion 56 of the operating trolleys 54a and 54b. The cable 32 may be connected to the operating trolleys 54a and 54b by a tensioning screw 64 threaded through another hole 63 which intersects hole 62 for the cable 32 in a substantially perpendicular manner. The tensioning screw 64 may then be tightened against the cable 32 to secure the cable 32 within the hole 62 to the mounting portion 56 of the operating trolleys 54a and 54b.

Optionally, a cable protector (not shown) may be provided between the tensioning screw 64 and the cable 32 to help prevent damage to the cable 32 and enhance performance of the tensioning screw 64 to secure the cable 32 in place. For example, the cable protector may include a “half-pipe” which can be fitted in the hole 62 between the cable 32 and the tensioning screw 64.

An optional tensioning spring 34 may also be provided for the cable 32, as mentioned above with reference to FIG. 2b, and shown in more detail with reference to FIGS. 5c-d. The tensioning spring 34 may be implemented to help reduce hang-ups, maintain cable tension, and ensure smooth operation of the trolleys 54. In an exemplary embodiment, the tensioning spring 34 may be connected inline with the cable 32, as shown in FIGS. 5c-d. Other embodiments are also contemplated, however. For example, the tensioning spring 34 may be mounted on one end to the trolley 54 and on the other end to the cable 32.

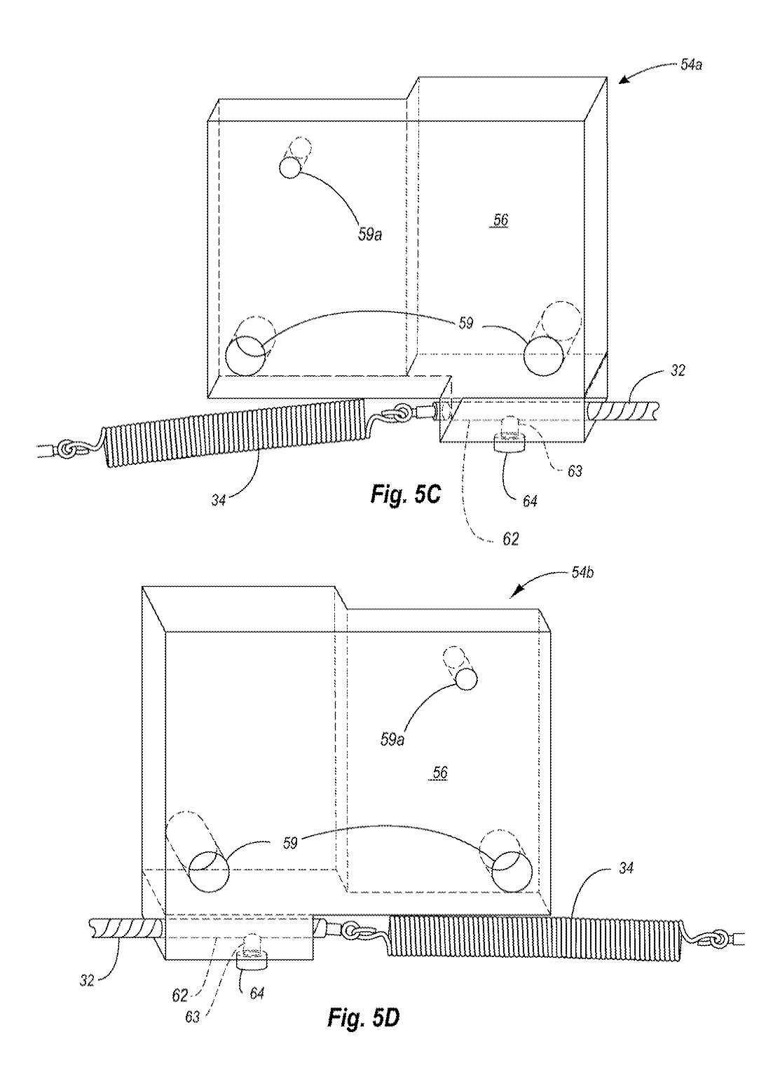

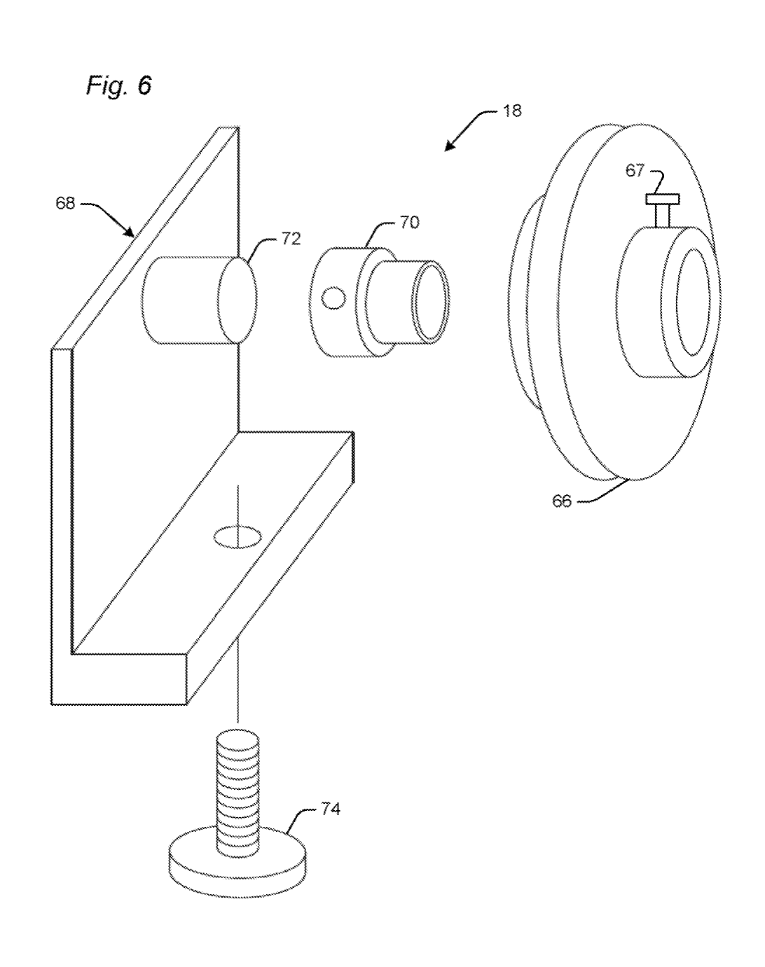

FIG. 6 is a perspective view of an exemplary pulley system 18 showing an exemplary pulley wheel 66 (e.g., pulley wheels 28a-b or 30a-b shown in FIG. 2b) and pulley mount 68 for mounting the pulley wheel 66 to a rail system 12. In an exemplary embodiment, the pulley wheel 66 may include a pin 67 for engaging a drive shaft (e.g., crank assembly 33 shown in FIG. 7 or other manual or automatic drive). The pulley wheel 66 may be mounted using bearing collar 70 to shaft 72 on the pulley mount 68 so that the pulley wheel 66 freely rotates in response movement of the cable 32 and/or is directly driven (e.g., manually or automatically, as discussed above). The pulley mount 68 may be secured to the housing base 20a or 20b (see FIG. 2b) by a fastener 74.

FIG. 7 is a perspective view of an exemplary crank assembly 33 that may be implemented to drive the pulley system (e.g., pulley wheel 66 in FIG. 6). Exemplary crank assembly 33 may include a substantially “L” shaped level 76 mounted to a “T” bar 78 for engaging a pulley wheel (e.g., the pulley wheel 66 shown in FIG. 6). Optionally, the L-shaped lever 76 may be pivotably mounted to the T-bar 78 so that a handle portion 80 of the crank assembly 33 may be pivoted in the directions illustrated by arrows 82. For example, the handle portion 80 may be pivoted toward the housing base and out of the way when the crank assembly 33 is not in use, and outward to effect rotation of T-bar 78 in the direction of arrow 84 when the crank assembly 33 is needed to drive the pulley system 18.

During operation, a user may grasp the handle portion 80 of the L-shaped lever 76 to rotate the crank assembly 33, thereby effecting a rotational movement about the T-bar 78 in the directions illustrated by arrows 84 to drive the pulley wheel (e.g., pulley wheel 66 attached to T-bar 78). An optional ball grip 86 may be rotatably mounted on the L-shaped handle portion 80 for the user to grasp, and enhances rotation of the crank assembly by rotating relative to the L-shaped handle portion 80 as illustrated by arrows 88.

It is noted that the crank assembly 33 may be permanently or removably mounted to a pulley wheel (e.g., the pulley wheel 66 shown in FIG. 6). Permanently mounting the crank assembly 33 helps ensure that it is not lost and always readily available for the user to operate the cover system 10. However, the crank assembly 33 may be removably mounted to the pulley wheel so that it may be readily replaced with an automatic drive for driving the pulley system. In addition, a manual drive (such as the crank assembly 33) may be provided as a backup to an automatic drive, e.g., for use if the automatic drive fails.

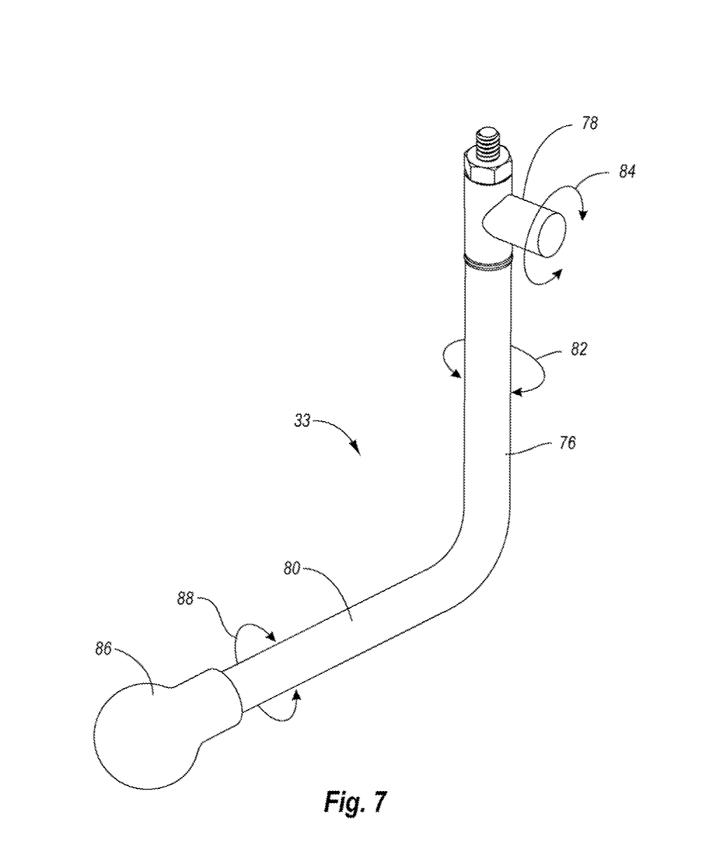

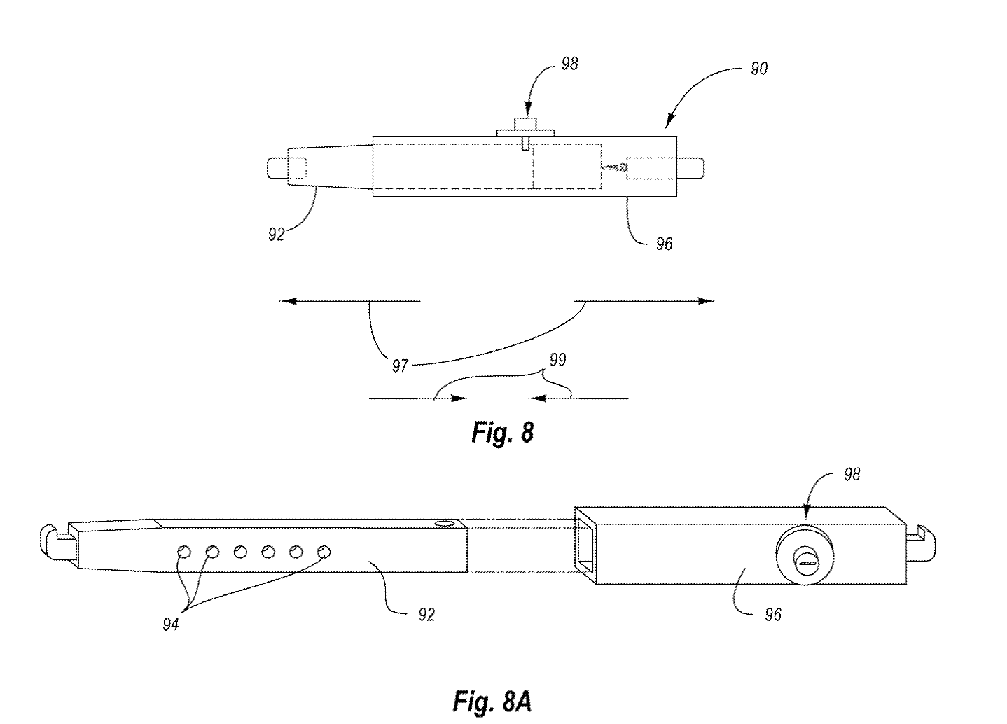

FIG. 8 is a perspective view of an exemplary lock assembly 90 that may be implemented with exemplary cover systems 10 to close and lock the curtain. FIG. 8(a) is a partial exploded perspective view of the exemplary assembly 90 shown in FIG. 8. The lock assembly 90 is optional and may be provided for the curtain 22, e.g., attached to the bottom portion of the curtain 22 so that the curtain 22 can be locked in the lowered position to fully close the cover system 10.

In an exemplary embodiment, the lock assembly 90 may include a sliding lock bar 92 having a plurality of openings 94 formed therein. The sliding lock bar 92 may be sized to fit within a fixed lock bar 96. The fixed lock bar 96 may include a pin or optional key lock 98 that may engage one of the plurality of openings 94 formed in the sliding lock bar 92 to hole the sliding lock bar 92 in a fixed or “locked” position relative to the fixed lock bar 96. Spring loaded clips 98a-b may also be provided on either end of the lock assembly 90 to engage mating connectors (not shown) on the housing bases 20a-b or directly on the vehicle itself.

During operation, the user may unlock the key lock 98 to release the sliding lock bar 92 from the fixed lock bar 96. The sliding lock bar 92 and fixed lock bar 96 may then be separated at least partially relative to one another in the direction of arrows 97, and thus disengage the clips 98a-b from the mating connectors to open the curtain 22. The sliding lock bar 92 and fixed lock bar may be pushed together in the direction of arrows 99 to engage the clips 98a-b from the mating connectors to secure the curtain 22 in a closed position.

It is noted that the exemplary lock assembly 90 is shown only for purposes of illustration and is not intended to be limiting. Other lock assemblies now known or later developed may also be implemented with the cover system 10. Alternatively, the curtain 22 may be closed with ties or other means and does not need to be locked.

Although the cover system 10 has been shown and described with reference to a specific implementation for purposes of illustration, the cover system is not limited to any particular implementation. Other embodiments will also be readily apparent to those having ordinary skill in the art after becoming familiar with the teachings herein. By way of example, the cover system 10 is not limited to any particular size, shape, or other configuration. Nor is the cover system 10 limited to manufacture from any particular materials. In addition, the components shown and described herein are shown for purposes of illustration. It is noted that these components may be modified, may be optional, and/or may not be needed at all in other embodiments. Such modifications and optional use of these components will be based at least in part on design considerations which will be readily apparent to one having ordinary skill in the art after becoming familiar with the teachings herein.

Exemplary Operation

FIGS. 9a-c are partial perspective view showing support bows 114a-d mounted in a housing base 120 on one side of an exemplary cover system 100 (e.g., the cover system 100) to illustrate exemplary operation of the cover system 100 to open and close a canopy (attached to the support bows 114a-d but not shown in FIGS. 9a-c) over at least a portion of a vehicle (also not shown in FIGS. 9a-c). In an exemplary embodiment, the support bows 114a-d move in response to manual or automatic operation of a pulley system 118 (e.g., the pulley system 18 shown in FIG. 2b) to open and close the canopy over at least a portion of the vehicle.

As described above, the front support bow 114a may be mounted to a front bow mount 150 (such as the front bow mount 50 shown in FIGS. 4 and 4a), which remains in a fixed position regardless of operation of the pulley system 118. The rear support bow 114d is attached to an operating trolley 154″ (e.g., operating trolleys 54 shown in FIGS. 5c and 5d) with wheels that roll in channel 152. The intermediate support bows 114b-c are mounted directly to wheels that roll in channel 152. The support bows 144a-d move in response to operation of the pulley system 118.

More specifically, the pulley system 118 may be operated to rotate the front and rear pulley wheels 128 and 130 (e.g., the pulley wheels 28b and 30b shown in FIG. 2b), and hence the cable 132. As discussed above, the operating trolley 154 is attached to the cable 132 and therefore moves with the cable 132, moving the rear support bow 114d in the direction illustrated by arrow 100 to open the canopy, or arrow 102 to close the canopy.

When the pulley system 118 is operated to move the cable 132 in the direction of arrow 100 to open the canopy, as illustrated going from FIG. 9a to FIG. 9b, the operating trolley 154 moves toward intermediate support bow 114c. When the operating trolley 154 comes into contact with the intermediate support bow 114c, as illustrated in FIG. 9b, continued operation of the pulley system 118 causes the operating trolley 154 to come into contact with and push against the intermediate support bow 114c. Accordingly, movement of the operating trolley 154 results in movement of intermediate support bow 114c, and hence support bows 114d and 114c both move in the direction of arrow 100.

Likewise, when intermediate support bow 114c comes into contact with intermediate support bow 114b, continued movement of the operating trolley 154 causes intermediate support bow 114b to also move, and hence the support bows 114d, 114c, and 114b all move in the direction of arrow 100. Continued operation of the pulley system 18 eventually results in the support bows 114b-d to collect at the front of the housing base 120 near or against the front support bow 114a, as illustrated in FIG. 9c.

When the pulley system 118 is operated to move the cable 132 in the direction of arrow 102 to close the canopy, as illustrated in FIG. 9a, the operating trolley 154 moves away from intermediate support bows 114c, as illustrated going from FIG. 9c to FIG. 9b. This movement causes the canopy to open up between the support bows 114d and 114c, until the canopy is stretched between the support bows 114d and 114c. Continued movement of the operating trolley 154 causes the stretched canopy to pull intermediate support bow 114c in the direction of arrow 102. Likewise, when the canopy stretches between intermediate support bows 114c and 114b, continued movement of the operating trolley 154 causes the stretched canopy to move support bow 114d and pull both intermediate support bows 114c and 114b in the direction of arrow 102. Continued operation of the pulley system 18 eventually results in the support bows 114b-d returning to the closed position illustrated in FIG. 9a.

Other Exemplary Embodiments

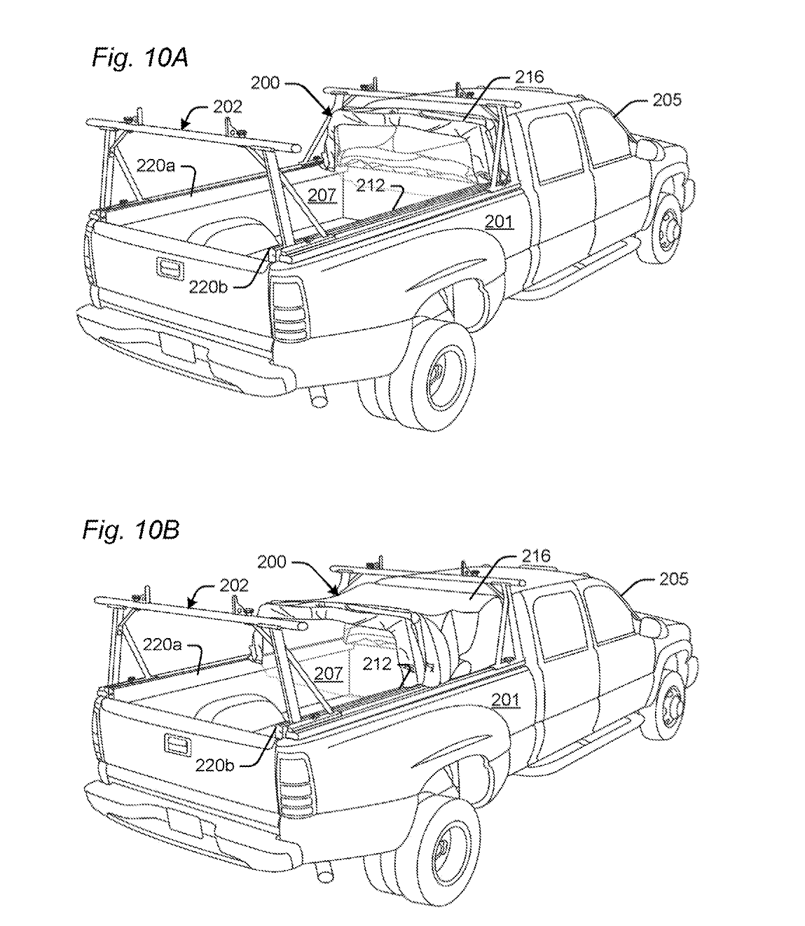

FIGS. 10a-c are perspective views of another exemplary cover system which may be implemented on a pickup truck, wherein (a) shows the cover system in a fully retracted position, (b) shows the cover system in an intermediate stage, and (c) shows the cover system in a fully closed position over the bed of the pickup truck. It is noted that 200-series references are used to refer to like elements described above and may not necessarily be shown and described again with reference to FIGS. 10a-c.

Although cover system 200 is described with reference to FIGS. 10a-c as it may be implemented with a full size pickup truck 205, it is noted that cover system 200 may be used with any of a wide variety of different sizes, types, and/or configurations of vehicles.

In this example, a rack assembly 202 is shown mounted to the truck bed 218. Rack assembly 202 may preclude use of a commercially available truck shell or tarp to cover the truck bed 207. However, cover system 200 can be readily configured for use with the pickup truck 205 and rack assembly 202 such that the rack assembly 202 does not interfere with operation of the cover system 200.

Exemplary cover system 200 may include a rail system 212 mounted to the pickup truck 205. One or more support bows (not visible in FIGS. 10a-c) attach to and provide support for a canopy 216 that may be used to cover a portion of the pickup truck 205 (e.g., the truck bed 207). The support bows may be movably mounted to the rail system 212 (e.g., via a pulley system such as the pulley system 18 described above). The pulley system may be operated to move the support bows to at least partially open and close the canopy 216 over a portion of the pickup truck 205, as illustrated in FIGS. 10a-c.

In exemplary embodiments, the rail system 212 includes first and second housing bases 220a and 220b. The housing bases 220a-b may be readily mounted to different parts of the pickup truck 205 and operated to open and close over at least part of the truck bed 207 even between the rack system 202.

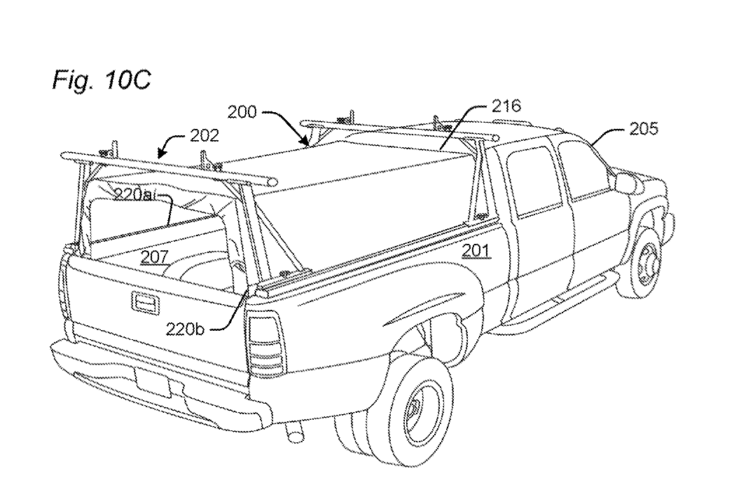

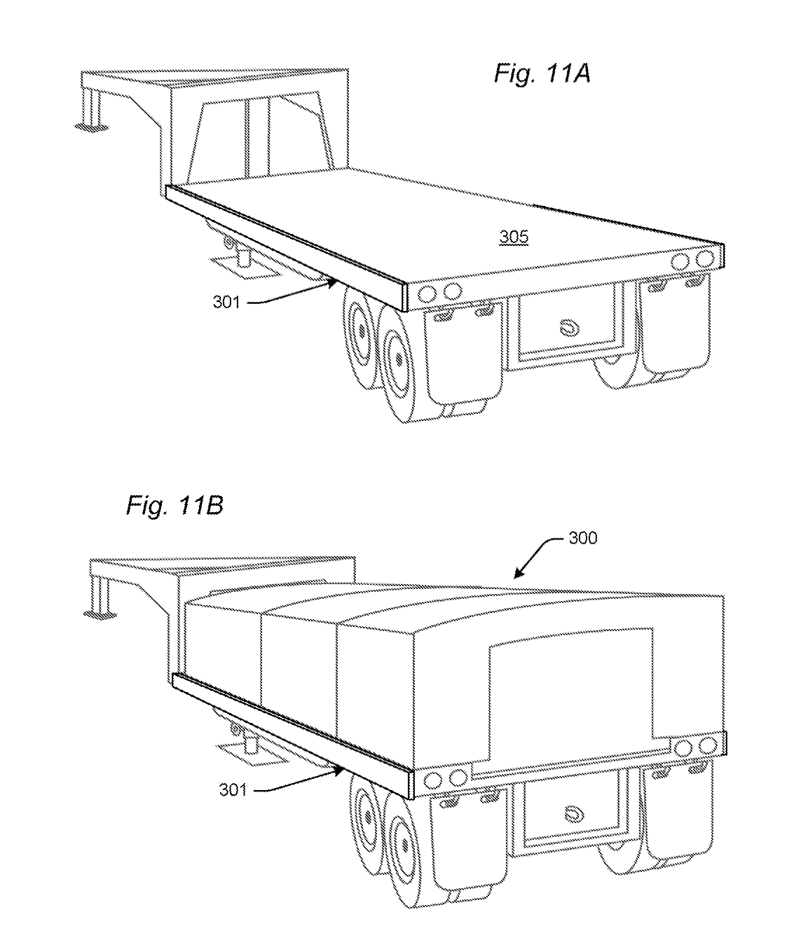

FIGS. 11a-b are perspective view of another exemplary cover system which may be side-mounted on a flatbed trailer, wherein (a) shows the flatbed trailer, and (b) shows the cover system in a fully closed position over the flatbed trailer. Although cover system 300 is described with reference to FIGS. 11a-b as it may be implemented with a flatbed trail 305, it is noted that cover system 300 may be used with any of a wide variety of different sizes, types, and/or configurations of vehicles. For example, FIGS. 12a-b are perspective view of another exemplary cover system which may be top-mounted on a flatbed trailer, wherein (a) shows the cover system in a partially retracted position, and (b) shows the cover system in a open position. It is noted that 300-series references are used to refer to like elements of the cover system which have already been described above with reference to cover system 10.

In these examples, substantially identical components may be manufactured for the cover system 300, and then may be configured for use on the flatbed trailer 305. In either embodiment, the cover system 300 may include a rail system 301 which may be mounted to the side of flatbed trailer 305 (FIGS. 11a-b), or a rail system 301′ which may be mounted to the top of flatbed trailer 305 (FIGS. 12a-b).

One ore more support bows (not visible) attach to and provide support for a canopy 316 that may be used to cover a portion of the flatbed trailer 306. The support bows may be movably mounted to the rail system (e.g., via a pulley system). The pulley system may be operated to move the support bows to at least partially open and close the canopy over a portion of the flatbed trailer 305, similarly to the exemplary operation of cover system 10 described above.

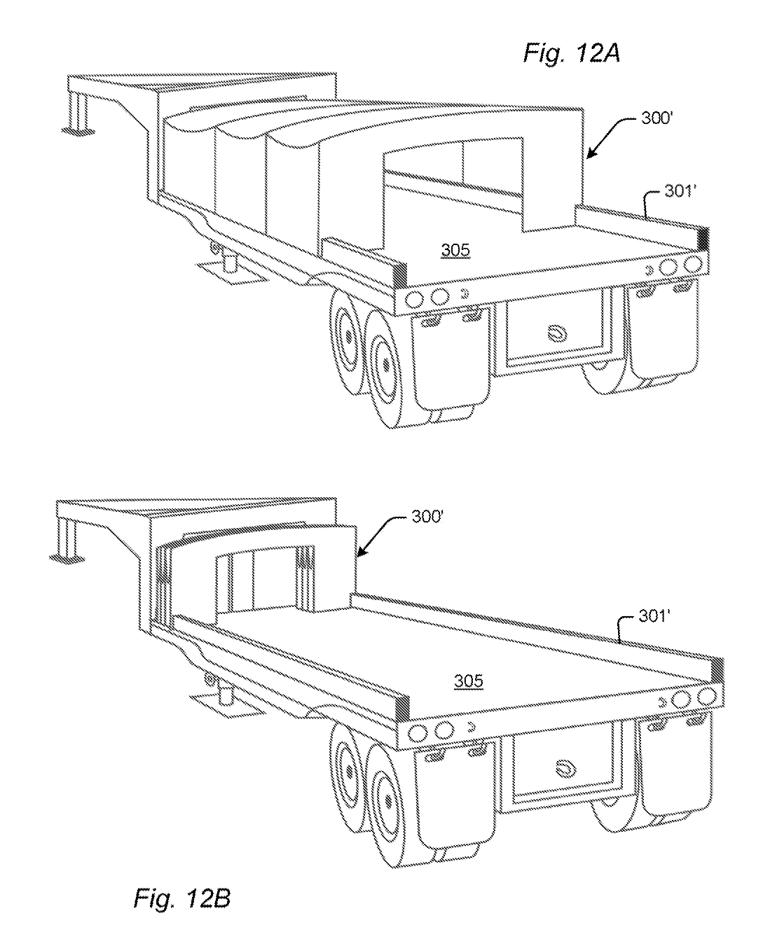

FIGS. 13a-b are perspective views of another exemplary cover system 300″ which may be mounted on a car hauling trailer 305′ with ramps for loading and unloading one or more vehicles from the car hauling trailer 305′. FIG. 13a shows the car hauling trailer 305′ without the cover system. Figure b shows the cover system 300″ in a closed position over the car hauling trailer. It is noted that the cover system 300″ also closes over the ramps as illustrated by portion 350. Cover system 300″ is particularly desirable for protecting the vehicle loaded on the car hauling trailer 305′.

Exemplary Optional Components

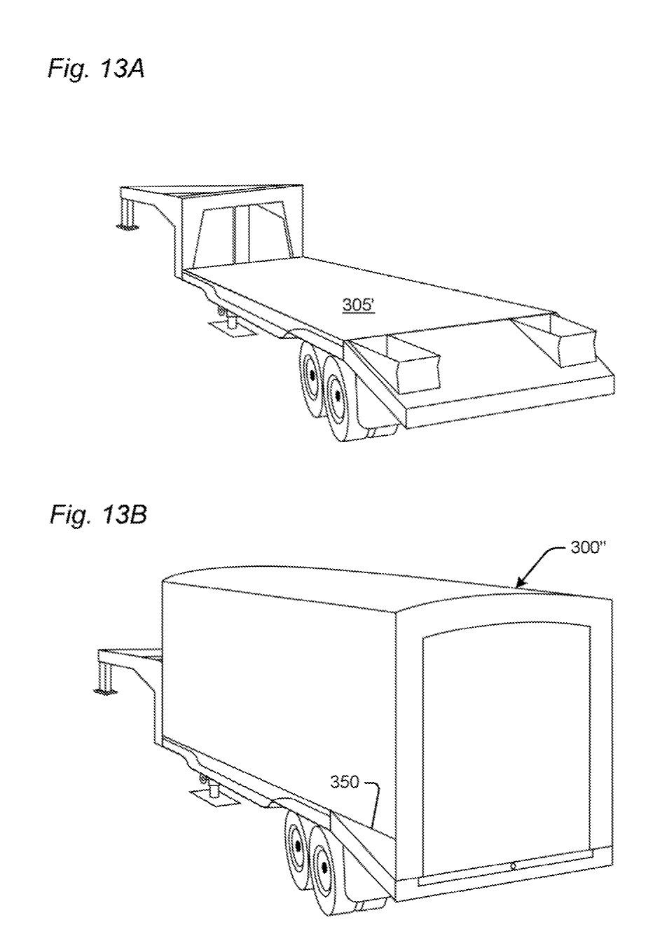

FIGS. 14-16 show exemplary optional components that may be provided for the cover systems. These optional components may be provided separately for use with the cover systems, or as part of the cover systems. It is noted that these optional components are shown and described only for purposes of illustration and are not intended to be limiting. Still other optional components may also be provided for the cover systems.

FIG. 14 is a perspective view of an exemplary bulkhead 400 that may be implemented with exemplary cover systems. Bulkhead 400 may be provided as an alternative to the front support bow and bow mount described above with reference to the cover system 10.

In an exemplary embodiment, the bulkhead 400 may be implemented wherein the cover system cannot be installed directly adjacent a wall (e.g., the passenger compartment wall) of the vehicle. For example, the bulkhead 400 may be used when the cover system is installed on a trailer. The bulkhead 400 provides a fixed surface for mounting the cover system at the front of the vehicle, and also serves to close the front portion of the cover system.

It is noted that the bulkhead 400 enables manufacture of substantially uniform components regardless of the vehicle configuration that the cover system may be used with. That is, the same cover system may be installed on vehicles having a passenger compartment as can be installed using the exemplary bulkhead 400 on a trailer or other vehicle which does not have a passenger compartment.

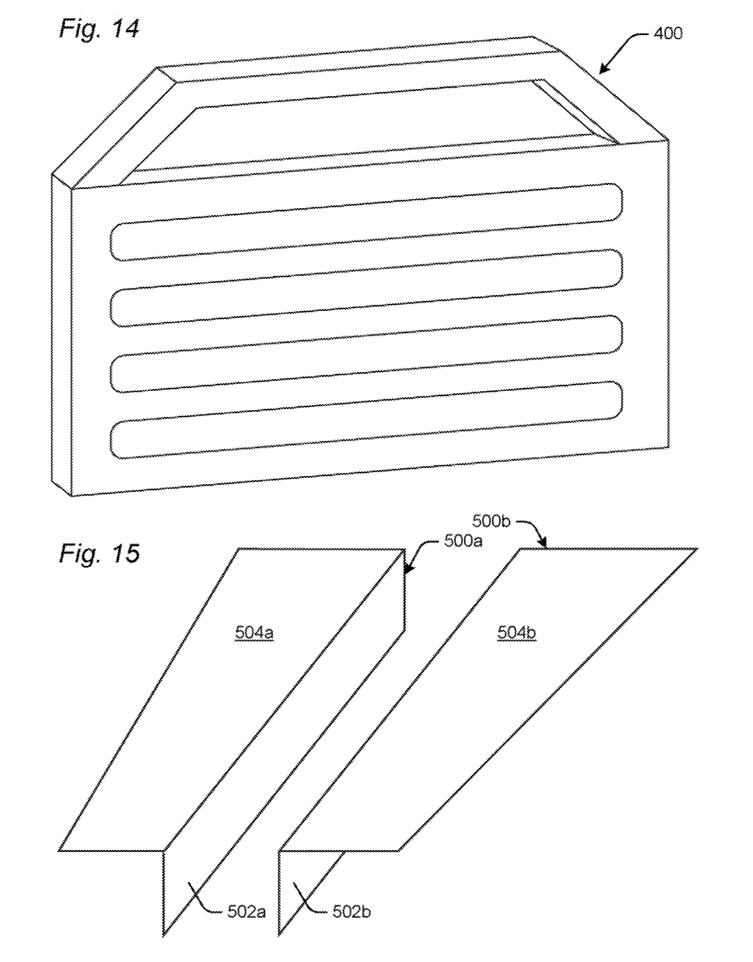

FIG. 15 is a perspective view of exemplary adapter rails 500a-b that may be implemented with exemplary cover systems. To clarify, some pickup trucks have bed walls (e.g., bed walls 201 shown in FIGS. 10a-c) that taper along the length of the truck bed. That is, the bed walls are farther apart from one another when measured across the width of the truck bed toward the front of the truck, and become narrower when measured across the width of the truck bed toward the back of the truck. Although this tapering may be difficult to discern by the untrained eye, if the housing bases of the cover system were to be mounted on tapered bed walls, the support bows may bind when moved through the tracks to open and close the canopy (e.g., the width of the truck bed increased or decreased and the support bows stayed the same width).

In an exemplary embodiment, each the housing bases of the cover system may be mounted to separate adapter rails 500a-b, e.g., to mounting surfaces 502a and 502b respectively. Accordingly, the housing bases are mounted in a substantially parallel, spaced-apart relation relative to one another across the entire width of the truck bed. Optionally, the top surfaces 504a-b of adapter rails 500a-b may also serve as a covers along the truck bed walls.

It is noted that the adapter rails 500a-b may also enable manufacture of substantially uniform components regardless of the vehicle configuration that the cover system may be used with. For example, the same housing bases that may be installed on the substantially parallel walls on a utility truck, may also be installed on tapered bed walls of a pickup truck using the exemplary adapter rails 500a-b.

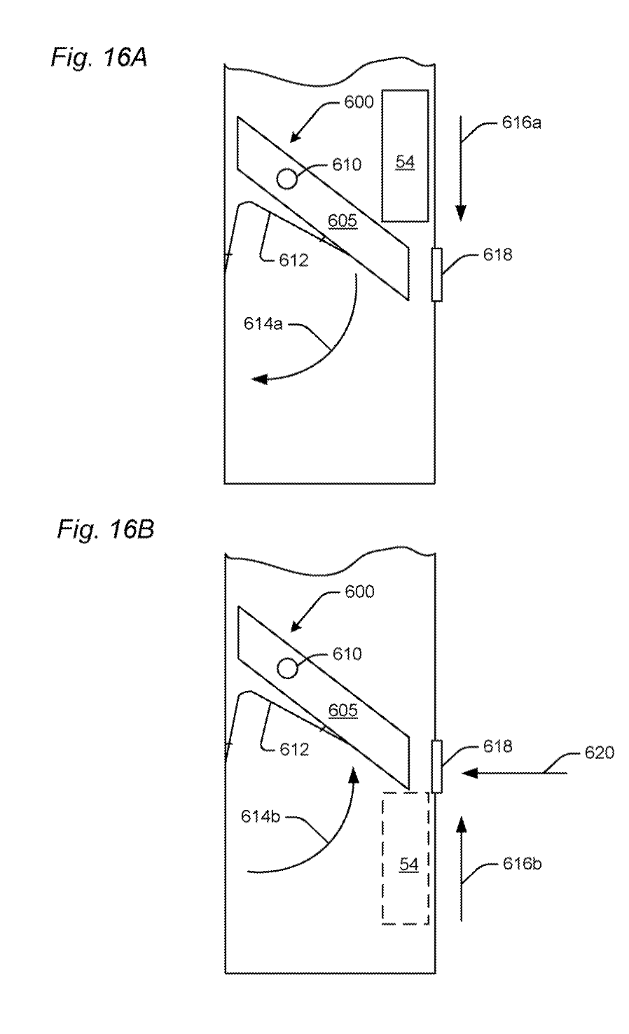

FIGS. 16a-b are top views of and exemplary lock system 600 that may be implemented for the trolleys (e.g., trolley 54 in FIG. 4) showing (a) the trolley 54 operated to automatically open the lock, and (b) the trolley 54 in the locked position. Lock system 600 may comprise a lever arm 605 pivotally connected at 610 in the rear portion of the channel (e.g., channels 52a, 52b in FIG. 2b). Lever arm 605 may be biased in a closed position by a spring member 612.

During operation, operating trolley 54 (e.g., FIG. 4) may move lever arm about pivot 610 in the direction indicated by arrow 614a as the operating trolley 54 is moved in the direction of arrow 616a. When operating trolley 54 passes by the lever arm 605, the spring member 612 causes the lever arm 605 to automatically pivot back into the closed position in the direction of arrow 614b, thereby securing the operating trolley 54 behind the lever arm 605, as illustrated in FIG. 16b. Accordingly, the cover system remains in a closed position.

When the user desires to open the cover system, a finger or tool can be inserted through an opening 618 formed in the outside of housing base 20, e.g., as illustrated by arrow 620. Optionally, the opening 618 may include a rubber insert to keep dirt and water out. The user manually moves the lever arm 605 in the direction of arrow 614a and releases the operating trolley 54 from behind the lever arm 605. Accordingly, the operating trolley 54 can be moved in the direction illustrated by arrow 616b to open the cover system, as described in more detail above with reference to FIGS. 9a-c.

In addition to the specific embodiments explicitly set forth herein, other aspects and implementations will be apparent to those skilled in the art from consideration of the specification disclosed herein. It is intended that the specification and illustrated implementations be considered as examples only.

1. A configurable vehicle cover, comprising:
a first housing base and a second housing base for mounting on a vehicle with asymmetrical sides, each housing base having at least one channel formed therein;
a pulley system mounted in the first and second housing bases, the pulley system operable to move a cable through the at least one channel formed in each housing base at substantially the same speed and in the same direction; and
at least one support bow mounted on one end to the cable in the at least one channel of the first housing base and mounted on an opposite end to the cable in the at least one channel of the second housing base, the at least one support bow moving between a retracted position and a closed position over the vehicle in response to operation of the pulley system.

2. The vehicle cover of claim 1 further comprising opposing operating trolleys connected to the cable for moving in each of the housing bases in response to operation of the pulley system, the operating trolleys connected only to each side of one support bow, other support bows slidably mounted in the housing bases but not connected to the cable and instead moving only in response to movement of the operating trolley.

3. The vehicle cover of claim 1 wherein the at least one support bow is a universal support bow adjustable for use on different types and configurations of vehicles.

4. The vehicle cover of claim 3 wherein the universal support bow includes on each side a lower bow member and an upper bow member adjustably connecting to one another so that the universal support bow is adjustable to different heights.

5. The vehicle cover of claim 4 wherein the universal support bow includes a bow coupler adjustably connecting to each of the upper bow members so that the universal support bow is adjustable to different widths.

6. The vehicle cover of claim 1 wherein the pulley system is operable by either a manual crank assembly or an electric motor.

7. The vehicle cover of claim 1 further comprising a tensioning mechanism for each cable.

8. The vehicle cover of claim 1 further comprising a curtain with a sliding lock bar for securing the curtain in a locked position, the sliding lock bar adjustable for different size vehicles.

9. The vehicle cover of claim 1 wherein the at least one support bow is mounted on each end to the cables by an operating trolley connected to the cable and riding in the channel formed in each housing base.

10. The vehicle cover of claim 1 wherein the at least one support bow and housing bases are configurable for use on different types of vehicles, including at least different size and shape pickup trucks and utility trucks.

11. The vehicle cover of claim 10 further comprising adapter rails for each side of a pickup truck bed with tapered bed walls, the adapter rails providing a mounting surface for the housing bases such that the housing bases are substantially equidistant from one another across the pickup truck bed.

12. A method of configuring a vehicle cover for use on different types of vehicles, comprising:
providing a first housing base and a second housing base for mounting on a vehicle regardless of configuration of the vehicle;
providing a pulley system for mounting in the first and second housing bases such that the pulley system is operable to move separate cables through each of the housing bases at substantially the same speed and in the same direction; and
providing at least one support bow for mounting on each end to the cables in each of the housing bases such that operating the pulley system moves the at least one support bow between a retracted position and a closed position over the vehicle.

13. The vehicle cover of claim 12 further comprising manufacturing substantially uniform components for the housing bases and at least one support bow for use on different configuration vehicles.

14. The vehicle cover of claim 12 wherein mounting the housing bases on the vehicle are at different heights from one another.

15. The vehicle cover of claim 12 further comprising providing the at least one support bow with lower bow members and upper bow members adjustably connecting to one another for different heights.

16. The vehicle cover of claim 12 further comprising providing the at least one support bow with a bow coupler adjustably connecting to other bow members for different widths.

17. The vehicle cover of claim 12 further comprising providing adapter rails for mounting the housing bases substantially equidistant from one another across on the vehicle if the vehicle has tapered sides.

18. A vehicle cover for use on different types of vehicles, comprising:
base means for housing separate cables on different portions of a vehicle regardless of configuration of the different portions of the vehicle;
means for moving the separate cables through the base means at substantially the same speed and in the same direction at the same time; and
means for mounting at least one support bow to the separate cables so that the separate cables move the at least one support bow between a retracted position and a closed position over the vehicle.

19. The vehicle cover of claim 18 further comprising universal support means for a canopy.

20. The vehicle cover of claim 18 further comprising means for aligning the base means even if the vehicle has tapered or uneven sides.
